(19) United States
(12) Patent Application Publication
(10) Pub. No.: US 2024/0112212 A1
(43) Pub. Date: Apr. 4, 2024

(54) System and Method for AI and Blockchain Consortium for Recruitment and Retention

(71) Applicant: 247 NewCoIT Corp. dba NurseBee, Dallas, TX (US)

(72) Inventors: Edward Navales, Dallas, TX (US); Amilcar Chavarria, Dublin, CA (US); Shivam Nalin Patel, Sunnyvale, CA (US)

(73) Assignee: 247 NewCoIT Corp. dba NurseBee, Dallas, TX (US)

(21) Appl. No.: 18/375,992

(22) Filed: Oct. 2, 2023

Related U.S. Application Data
(60) Provisional application No. 63/412,424, filed on Oct. 1, 2022.

(51) Int. Cl. G06Q 30/0208; G06Q 10/1053; G07C 13/00; H04L 9/00

(52) U.S. Cl. CPC G06Q 30/0208; G06Q 10/1053; G07C 13/00; H04L 9/50

(57) ABSTRACT

The present invention is a blockchain-driven ecosystem that aims to make nurses' lives easier by providing them with the best employment opportunities, benefits, and services. This helps nurses by reducing stress and burnout while providing benefits such as insurance, retirement advice, and education. The ecosystem is comprised of participants which include clinicians, facilities, vendors, recruiters, service providers, contributors, and franchisees. A rewards system is triggered by the actions of the different participants. Rewards can be used to purchase services from service providers in a rewards redemption application. Each participant can earn and spend rewards in the ecosystem. Rewards can be converted into stablecoins to withdraw them to a bank account. The platform is built on the Ethereum Virtual Machine with blockchain bridging capacity. It uses smart contracts to execute payouts, take and record votes, record rewards earned, and store medical credentials.

### PRIORITY STATEMENT

This application claims priority to provisional application No. 63/412,424, filed Oct. 1, 2022 which is hereby incorporated by reference in its entirety.

### BACKGROUND OF THE INVENTION

In recent years, the healthcare industry has experienced significant challenges in recruiting and retaining qualified medical staff, particularly nurses, resulting in understaffing issues that compromise patient care. Traditional staffing methods have proven to be inefficient, costly, and time-consuming, exacerbating the shortage of healthcare professionals. In this context, the invention under consideration operates within the realm of medical staffing and recruitment, with a specific focus on registered nurses, who play a pivotal role in the healthcare ecosystem. This field has long grappled with persistent pain points that have far-reaching implications for healthcare institutions and medical professionals alike.

The challenges within the medical staffing arena encompass various aspects. The top issue in the healthcare industry is that demand for talent outpaces supply by a factor of seven. Healthcare facilities are burdened with the arduous task of identifying suitable candidates from a large pool of applicants, a process that often involves time-consuming credential verification and exhaustive interviews. These traditional recruitment methods not only strain the resources of healthcare institutions but also lead to prolonged staffing gaps, which can critically affect the quality of patient care.

Applications such as Intelycare, SnapNurse, Vivian, and Nomad Health all aim to address staffing challenges in the healthcare industry by leveraging technology to match qualified healthcare professionals with facilities in need of their services. Intelycare specializes in on demand staffing solutions for nursing homes and long-term care facilities. SnapNurse enables all healthcare facilities to find and hire nurses quickly and provide them with flexible work opportunities. Vivian connects travel nurses with healthcare facilities across the United States and manages assignments. Nomad Health enables nurses and doctors to find permanent and travel assignments and apply for positions directly on the platform. While most platforms offer a pool in certain highly sought-after roles (doctors, nurses, etc.), there is no convenient and highly-liquid, all-encompassing access into the medical staffing world for holders of other less-esteemed roles in the field.

Simultaneously, medical professionals, including nurses, face a complex and often opaque job market. The search for positions that align with their skills, preferences, and career aspirations can be a daunting and uncertain process. Credential verification, a crucial aspect of securing employment in healthcare, can also prove cumbersome and slow, delaying job placement and potentially causing frustration among professionals.

Considering these challenges, the field of medical staffing stands in urgent need of improvement. Healthcare institutions require more efficient and cost-effective means of identifying and onboarding qualified staff swiftly to ensure uninterrupted patient care. Likewise, medical professionals seek a transparent and supportive system that can facilitate their career advancement without undue delays and uncertainty. The present invention aspires to address these pressing needs, ushering in a new era characterized by enhanced efficiency, transparency, and satisfaction for both healthcare institutions and medical professionals within this vital field.

### BRIEF SUMMARY OF THE INVENTION

The NurseBee platform is a blockchain-driven ecosystem that aims to make nurses' lives easier by providing them with the best employment opportunities, benefits, and services. This helps nurses by reducing stress and burnout while providing benefits such as insurance, retirement advice, and education.

The NurseBee blockchain consortium and ecosystem, called the “Hive,” is comprised of Hive participants which include clinicians, facilities, vendors, recruiters, service providers, contributors, and franchisees. A rewards system is triggered by the actions of the different Hive participants. For example, nurses create a profile on the NurseBee platform and start earning honey, a token, by completing shifts, referring other nurses, and participating in polls. Nurses can use honey to purchase services (such as childcare, financial advice, or mental health support) from service providers in a rewards redemption application. Nurses can also convert honey to stablecoins and withdraw them to their bank account. The platform is built on the Ethereum Virtual Machine with blockchain bridging capacity. It integrates NurseBee's needs in smart contracts to, for example, execute payouts, record rewards earned, and store medical credentials.

The NurseBee platform not only addresses the critical staffing challenges in the healthcare industry but also harnesses the collective strength of its blockchain consortium, which comprises thousands of nurses. This vast network of medical professionals wields substantial purchasing power and influence. NurseBee's unique approach allows external entities, such as insurance companies or banking partners, to become service providers within the ecosystem. These partners recognize the value of engaging with the NurseBee community, and in return, they contribute to the system's growth.

The NurseBee system generates fees through profit-sharing with its service providers. Fees are collected in the HoneyPot, a treasury account on the blockchain such as a wallet.

NurseBee is governed by a decentralized autonomous organization (DAO), which gives all members of the ecosystem a say in how the platform is run. Nurses, recruiters, facilities, and service providers can vote on important decisions, such as how to distribute profits from the HoneyPot, new service providers, whether or not to launch a new coin to power the ecosystem, and which transactions should be free or paid.

As token holders within the blockchain consortium, nurses possess a significant role in the governance of the platform. They actively participate in shaping the range of services available to nurses and play a vital role in determining how nurses are rewarded for their involvement in the consortium. This decentralized decision-making process ensures that the platform remains responsive to the needs and preferences of the nursing community. NurseBee's ecosystem, enhanced by the “Honey” token, not only streamlines staffing but also empowers nurses and other stakeholders, making it a transformative force in the medical staffing landscape.

### BRIEF DESCRIPTION OF THE DRAWINGS

Illustrated in the accompanying drawing(s) are embodiments of the present invention in such drawings:

FIG. 1 shows the parties and dataflow of the NurseBee blockchain consortium ecosystem;

FIG. 2 shows the network arrangement of the various computing devices utilized by the NurseBee blockchain consortium ecosystem;

FIG. 3 shows the internal structure of the NurseBee system;

FIG. 4 shows the process that enables a new service provider to offer services on the NurseBee platform; and

FIG. 5 shows the NurseBee platform process blockchain-based opportunity matching.

The above-described figures illustrate the described apparatus and its method of use in several preferred embodiments, which are further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

### DETAILED DESCRIPTION OF THE INVENTION

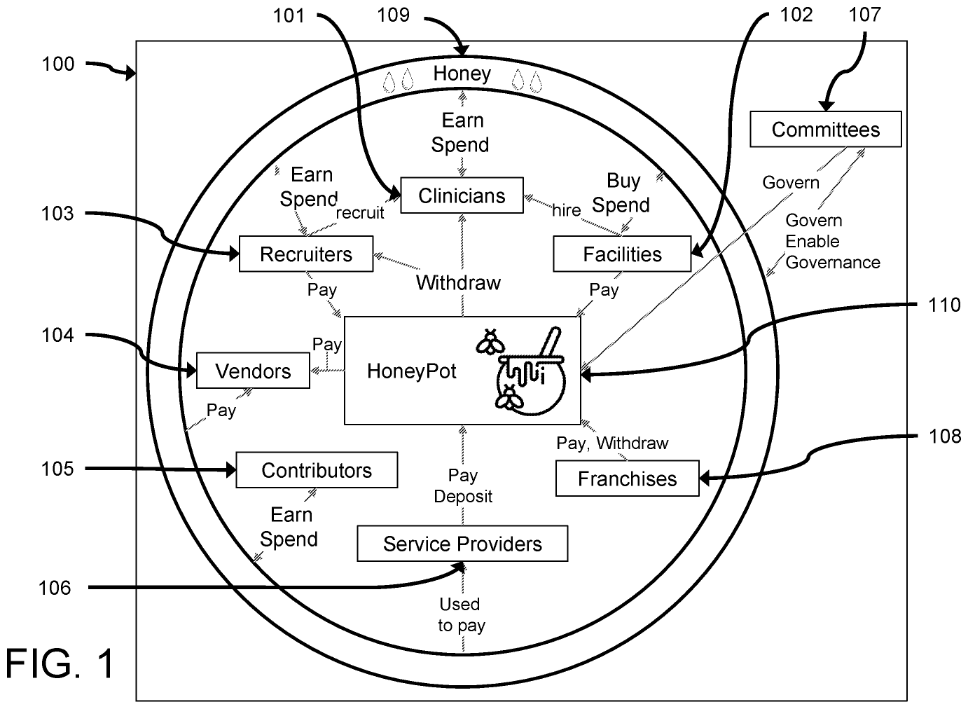

As shown in FIG. 1, the NurseBee Blockchain ecosystem 100 (Hive) is comprised of Hive participants including clinicians 101, facilities 102, recruiters 103, vendors 104, contributors 105, service providers 106, committees 107, and franchisees 108. Each participant operates as a moving part of an efficient consortium of participants for the betterment of a nurse's life.

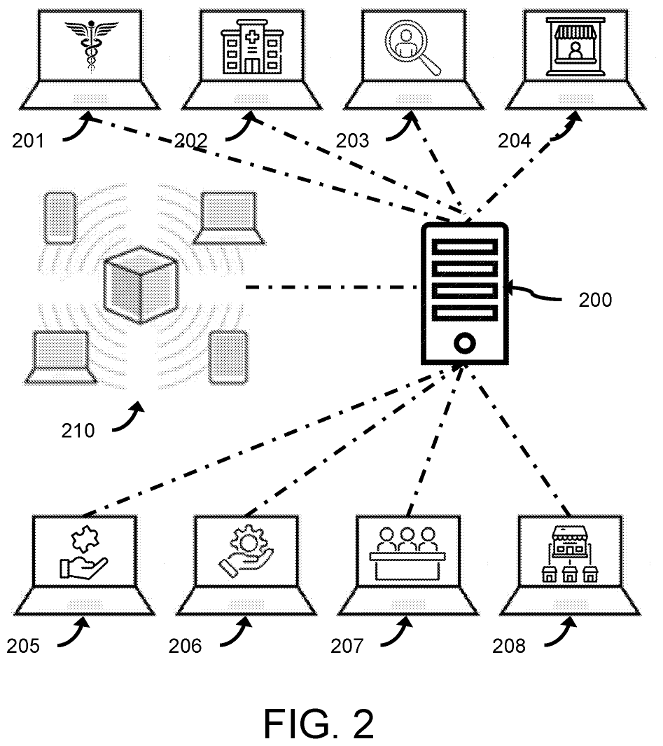

FIG. 2 shows the network arrangement of the various computing devices of clinicians 201, facilities 202, recruiters 203, vendors 204, contributors 205, service providers 206, committees 207, and franchisees 208 interact with the NurseBee webserver 200 utilizing the blockchain 210 to distribute and redeem tokens according to one or more smart contracts. The systems and methods of the NurseBee webserver 200 include virtual ledger operations (e.g., blockchain operations, etc.), as performed by the engine server 102. The server 102 is also configured to perform various functions, such as user interface (UI), artificial intelligence (AI), database management functions, treasury management, and the like. The AI functionality, can include TensorFlow (an open-source machine learning library developed by Google), PyTorch (an open-source machine learning library developed by Facebook), Keras (a high-level neural networks API written in Python and capable of running on top of TensorFlow, Theano, or CNTK), Caffe (a deep learning framework developed by the Berkeley Vision and Learning Center (BVLC)), the Microsoft Cognitive Toolkit (formerly known as CNTK, a free, open-source toolkit for deep learning developed by Microsoft), MXNet (a deep learning framework developed by Apache), Hugging Face (a platform for creating and sharing state-of-the-art models for natural language processing and computer vision), OpenAI (a research organization focused on developing advanced AI technologies and promoting their safe and beneficial use, such as ChatGPT, Midjourney, etc.), IBM Watson (a suite of AI-powered services and tools for businesses, developers, and researchers, Amazon Web Services (AWS) AI (a set of cloud-based services and tools for building and deploying AI applications), and the like.

The Blockchain is the most reliable environment for accurately collating the referrals and the safety of the credentials on the platform. Blockchain technology provides an extra layer of transparency for medical practitioners, facilities, and network participants—a multi-market pool aimed at satiating medical demand melted into a single highly functional platform.

Blockchain technology can offer several benefits and applications in the field of medical recruiting. Potential uses of blockchain in this context include:
1. Candidate Credential Verification: Blockchain can provide a secure and decentralized platform for verifying and storing candidate credentials, such as education degrees, certifications, licenses, and work experience. This eliminates the need for manual verification processes and enhances the trustworthiness and efficiency of credential verification.
2. Data Privacy and Security: Blockchain's decentralized nature and cryptographic principles can help protect sensitive candidate data, ensuring privacy and security throughout the recruiting process. Candidates can have control over their personal information and grant selective access to recruiters or institutions, reducing the risk of data breaches and identity theft.
3. Smart Contracts for Hiring Agreements: Smart contracts, powered by blockchain, can facilitate transparent and automated hiring agreements. The terms and conditions of employment contracts, including compensation, benefits, and job responsibilities, can be encoded into smart contracts, ensuring transparency, accuracy, and enforceability.
4. Candidate Reputation and Feedback: Blockchain-based reputation systems can enable the collection and verification of feedback and reviews from employers, colleagues, and patients regarding a candidate's professional performance, skills, and ethics. This can provide valuable insights for recruiters during the candidate evaluation process.
5. Immutable Audit Trail: Blockchain's inherent immutability and transparency can create an audit trail of all interactions and transactions throughout the recruiting process. This allows for easy traceability and verification of recruitment activities, ensuring compliance with regulatory requirements and reducing the risk of fraud or manipulation.
6. Decentralized Job Marketplaces: Blockchain can enable the creation of decentralized job marketplaces, where candidates and employers can connect directly, without intermediaries. This eliminates traditional gatekeepers and reduces costs, while empowering candidates to have more control over their career opportunities.

As shown in FIG. 1, the Hive 100 is a the blockchain consortium where all activities take place. The Hive is a permissioned blockchain. The Hive makes money via consortium membership fees, platform licensing fees, traditional talent brokering fees, premium services, financial services, franchise fees, and transactional fees from all activities in the Hive. These revenues can be shared with the platform for operating expenses. The revenues can also be stored in a HoneyPot 101 for future payment distributions, new proposals (e.g., matching 401k), and other benefits that make nurses' lives easier. The interactions with Honey 109 and the HoneyPot 100 shown in FIG. 1 are not intended to be limiting. The shown interactions are meant to highlight the most important features. Essentially, each participant has the ability to collect, store, and send Honey.

Honey 101, the internal currency (token) in The Hive, can be distributed when a nurse is connected with a new opportunity (job order) and for actions performed in the NurseBee ecosystem. Honey can be rewarded for being a valued member of the ecosystem. Honey can be paid out via a stablecoin (such as USDC, USDT, DAI, and XLM) to Nurses and other members of The Hive. Tokens refer to a special kind of virtual currency token that resides on its own blockchain and represents an asset or utility. Tokens often serve as the transaction units on blockchains. These blockchains work on the concept of smart contracts or decentralized applications, where the programmable, self-executing code is used to process and manage the various transactions occurring on the blockchain. Tokens are tradable and transferrable among the various participants of a blockchain.

Clinicians 101 (workers) can be any type of worker such as nurses, travel nurses, physicians, and specialists. Everything around The Hive revolves around them. Clinicians 110 benefit from work, perks, benefits, and services. Clinicians 100 earn Honey 109 for tasks on the NurseBee platform and can spend Honey 109 on various services offered by Service Providers 106. Clinicians 101 are recruited by Recruiters 104 and hired by Facilities (Employers) 102.

Recruiters 103 help to connect Clinicians 101 such as nurses with opportunities (job orders). They provide contacts and connections to enable the ecosystem to thrive. Recruiters 103 earn fees from rewards such as Honey 109 by sharing contacts and connecting Clinicians 101 or NurseBee with Facilities (Employers) 1. To fuel platform adoption, Recruiters 103 can be permitted to join for free and can earn Honey 109 by conducting their business within the NurseBee ecosystem 100. At scale, Recruiters 103 will purchase Honey 109 to have access to the ecosystem 100 and those fees will go directly to the HoneyPot 110.

Contributors 105 are any person in the ecosystem 100 that is incentivized to make it work. For example, a Contributor 105 may draft a DAO proposal for nurses. Contributors can also help with sourcing, as influencers, or with other tasks.

Service Providers 106 provide services, benefits, and perks to the Clinicians 101 or to others in the Hive. Examples of service providers include insurance companies, an insuretech marketplace, banks, education providers, credentialing companies, and wellness providers. Each service provider transaction can yield commissions that feed into the HoneyPot 110. Service Providers 106 split revenues with NurseBee.

Facilities/Employers/Plants 102 such as long-term care facilities, hospitals, nursing homes, schools, and acute care facilities hire Clinicians 101 through the NurseBee platform with or without the help of Recruiters 103. If a Recruiter 103 provided the referral, the Recruiter 103 can be compensated with Honey tokens 109. Facilities (Employers) 102 can use Honey 109 for access to top talent, to fulfill a shortage, tool access, services access, access to clinicians on the move, rewards, and credits. At first launch, custom workflows enable Facilities 102 to join the ecosystem 100, post opportunities, and evaluate candidates. At scale, Facilities 102 will purchase Honey 109 to have access to the ecosystem and those fees will go directly to the HoneyPot 110.

Vendors 104 such as AI-driven companies, data providers, SaaS companies (such as Slack or Zapier), and Application Tracking Systems (such as Labor Edge) get paid with fiat currency or Honey 109 for services rendered to the ecosystem or the NurseBee platform.

Committees 107 are the corporate analogs of a board of directors or specific committees such as a compensation committee. Committees 107 can be formed to manage the HoneyPot (Treasury) 110 and for governance of the ecosystem 100. A committee can be formed by any Hive member to generate improvement proposals that will get voted on by community members. Committees can earn Honey for helping in governance. The NurseBee platform brings many different types of participants together in a variety of interactions. For example, one type of participant can vote on topics that affect another type of participant because many different participants can own Honey 109. Disputes are bound to happen between the participants and those could be resolved via proposal and get voted on by Honey token holders. The Treasury Management function of the HoneyPot 110 is effectively finance and accounting departments—but with full transparency because all transactions are the blockchain and therefore by definition are on a distributed ledger that all Hive participants can see. Members can form Committees that generate proposals on the functioning of treasury management, service providers and any other proposals that makes Clinicians lives easier. This process is driven by a community approach to self-governance using Honey to affect voting power. Honey is earned by ecosystem participants by performing actions on the NurseBee Platform in its various forms—web, mobile app or blockchain wallet.

### Governance

The NurseBee platform provides Hive Participants with mechanisms to have both a stake and a say regarding how all Honey is distributed inside the Hive as an ecosystem. None of the existing medical staffing apps (Nomad Health, SnapNurse, Intelycare, Clipboard Health) provide nurses the ability to vote on what should be built and for the app to give them what they want. Nurses, Recruiters, Facilities, and Service Providers can cast votes for crucial decisions such as:
Distribution of profits from The HoneyPot, including a distribution schedule and amounts to be paid;
Whether or not to launch a new coin to power the ecosystem in the form of a token sale (In this case, Honey will become the token offered to the public and used to cast votes or pay for services. USDC will remain one of the stablecoins in which to pay rewards.);
Which transactions should be free vs. paid in the ecosystem;
Composition of a Clinical Advisory Boards—to make decisions on behalf of the Hive participants;
New oversight committees (e.g., transparency requests, financials);
What types of services and which specific services should be offered in The Hive (e.g., 401k, insurance); and
Whether or not to approve a new consortium member, for example, a service provider

### Voting & Proposal Process

A DAO is a blockchain-based form of organization or company that is often governed by a crypto token. Anyone who purchases and holds these tokens gains the ability to vote on important matters directly related to the DAO. DAOs typically use smart contracts in place of traditional corporate structures to coordinate the efforts and resources of many towards common aims.

DAO is a new type of digital-first entity that shares similarities with a traditional company structure but has some additional features, such as the automatic enforcement of operating rules via smart contracts (we'll explain more about these and why they are so interesting). DAOs come in many structures, but all operate as collectives in which members make decisions democratically. No single person exerts control in the way a conventional CEO or senior management team would. DAOs are self-executing computer programs that carry out a particular function when certain conditions are met.

DAOs typically raise funds by issuing tokens, a form of digital currency tied to the smart contract. The tokens represent a form of ownership but are not the same as traditional equity and do not function as investment contracts; rather, they are akin to contributions that bestow governance rights but not ownership. Most DAOs are not directly owned by anyone in the traditional sense. Token owners put forward proposals about the DAO's operations, then the community votes on each idea.

DAI is a stablecoin on the Ethereum blockchain whose value is kept as close to the US Dollar as possible. DAI is governed by MakerDAO, a decentralized autonomous organization composed of the owners of its governance token, MKR, who may propose and vote on changes to certain parameters in its smart contacts in order to ensure the stability of DAI.

Similar to Maker DAO, the NurseBee DAO enables:
Any member of the ecosystem can suggest a proposal for improvement.
A user's voting power will be proportional to the number of rewards or internal (Honey) earned in the NurseBee ecosystem.

In one embodiment, the NurseBee platform can be franchised as a white label by, for example, an independent medical staffing agency that operates in one or more states. As shown in FIG. 1, Franchises 108 pay franchising, software licensing, and transactional fees. For example, all franchises would pay royalties from connecting clinicians to opportunities (job orders). A portion of these fees is sent to the HoneyPot 110 for distribution to Hive participants such as Clinicians 101, Recruiters 103, Contributors 104, and Committees 107 or any enablers of the transaction. A minimum floor price is set per franchise per year. A Franchise 108 can modify HoneyPot tokenomics as long as the floor price is met. Franchisees benefit from NurseBee's recruiting automation, credentialing speed, turnkey solutions, and proven model and expertise.

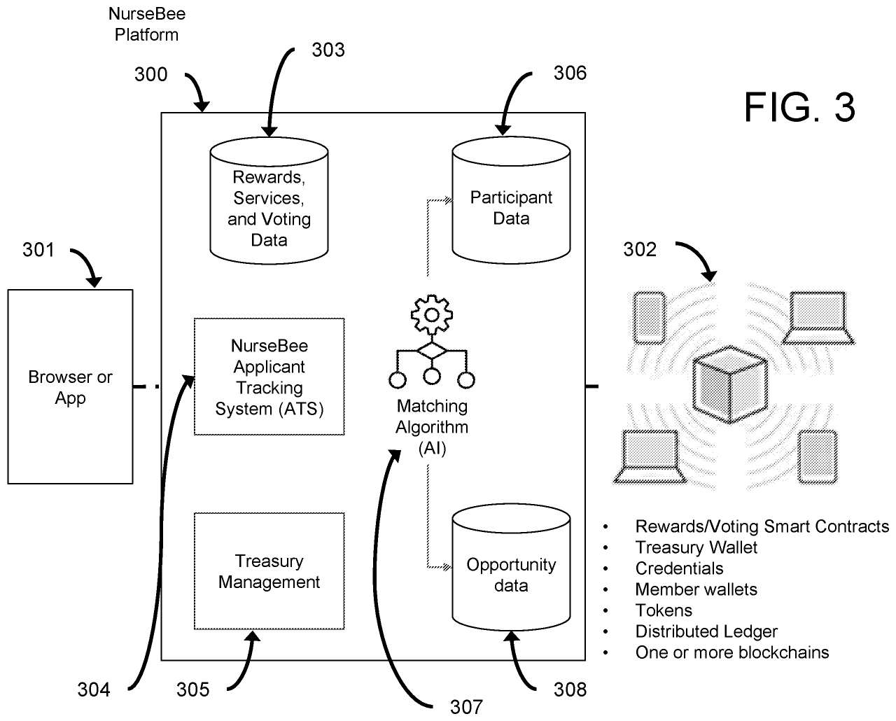

A method is provided for controlling service offerings in a blockchain consortium and ecosystem. As shown in FIG. 3, the NurseBee Platform 300 comprises a voting database/interface 303 which receives votes from token (honey) holders listed in the member database 304. Votes may be taken to determine whether or not to include/offer a new service (such as a new insurance offering or a new banking service) on the NurseBee Platform 300. In one embodiment, voting may be accomplished through a distributed autonomous organization (DAO). The votes are processed through one or more smart contracts stored on a blockchain 302 utilizing the NurseBee Platform server(s). In another embodiment, voting may be accomplished through any voting software such as eBallot or ElectionBuddy.

Distribution of tokens is governed by smart contracts stored on the blockchain 302. If the NurseBee Platform 300 and its underlying processors, via smart contract nodes or other voting platforms, determine that the new service is voted in, the NurseBee platform notifies the service provider and requests a platform fee from the service provider. The service provider pays the platform fee via the treasury management interface 307 and the fee is transferred into the treasury, preferably a crypto wallet such as MetaMask.

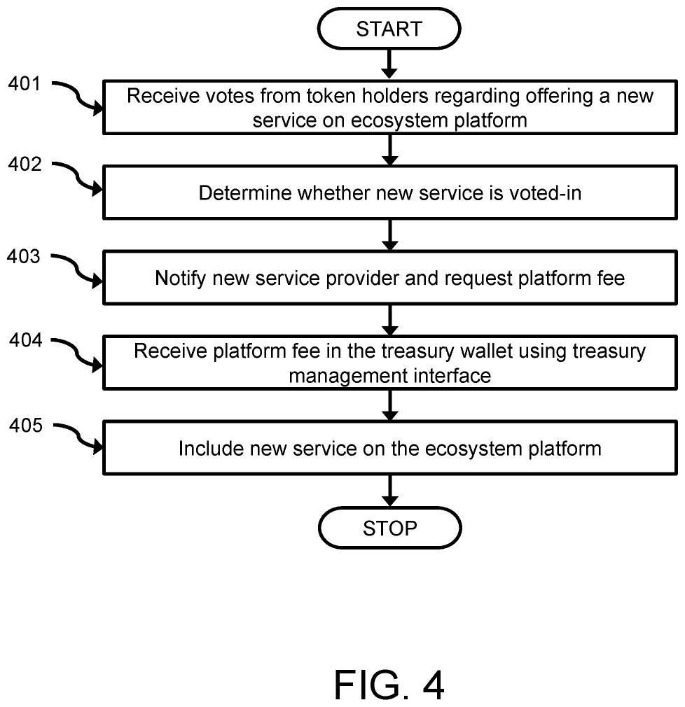

Thus, FIG. 4 shows the process for controlling service offerings in blockchain consortium and ecosystem. In step 401, the NurseBee platform receives votes from token holders regarding offering a new service on the platform. In step 402, the NurseBee platform determines whether the new service is voted-in. In step 403, the NurseBee platform notifies the new service provider that the new service has been voted-in and requests a platform fee. In step 404, the new service provider pays the platform fee which is received by the treasury wallet. In step 405, the new service is included on the NurseBee platform as a service offering. The new service can be offered for free to certain Hive participants such as clinicians if the DAO votes for it to be. Otherwise, the service is offered in exchange for Honey or money to the Hive participants.

A method is provided for controlling service offerings in a blockchain consortium and ecosystem. As shown in FIG. 3, the NurseBee Platform 300 comprises a voting database/interface 303 which receives votes from token (honey) holders listed in the particpant database 306. Votes may be taken to determine whether or not to include/offer a new service (such as a new insurance offering or a new banking service) on the NurseBee Platform 300. In one embodiment, voting may be accomplished through a distributed autonomous organization (DAO). The votes are processed through one or more smart contracts stored on a blockchain 302 utilizing the NurseBee Platform server(s). In another embodiment, voting may be accomplished through any voting software such as eBallot or ElectionBuddy.

Distribution of tokens is governed by smart contracts stored on the blockchain 302. If the NurseBee Platform 300 and its underlying processors, via smart contract nodes or other voting platforms, determine that the new service is votedi in, the NurseBee platform notifies the service provider that the new service is voted-in and requests a platform fee from the service provider. The service provider pays the platform fee via the treasury management interface 306 and the fee is transferred into the treasury, preferably a crypto wallet such as MetaMaskA

Thus, FIG. 4 shows the process for controlling service offerings in blockchain consortium and ecosystem. In step 401, the NurseBee platform receives votes from token holders regarding offering a new service on the platform. In step 402, smart contracts or other voting software determines whether the new service is voted-in. In step 403, the NurseBee platform notifies the new service provider that the new service has been voted-in and requests a platform fee. In step 404, the new service provider pays the platform fee which is received by the treasury wallet. In step 405, the new service is included on the NurseBee platform as a service offering. The new service can be offered for free to certain Hive participants such as clinicians if the DAO votes for it to be. Otherwise, the service is offered in exchange for Honey or money to the Hive participants.

A method is provided for enabling a recruiter or employer in a blockchain consortium and ecosystem to input an opportunity (job order) using reward tokens earned according to a smart contract and receive matches. As shown in FIG. 3, the NurseBee Platform 300 comprises a rewards database/interface 303 enabling a recruiter to earn one or more token rewards according to a smart contract stored on a blockchain 302. A recruiter (opportunity poster) can post/input an opportunity (job order) into an opportunity database 308. Honey (tokens) can be provided to the recruiter as a reward for uploading the opportunity. Resumes (worker profiles) are stored in a worker/participant database 306. An artificial intelligence (AI) matching algorithm 307 matches worker data 306 with opportunity data 308, generates a match, and sends it one or more of the worker and the opportunity poster.

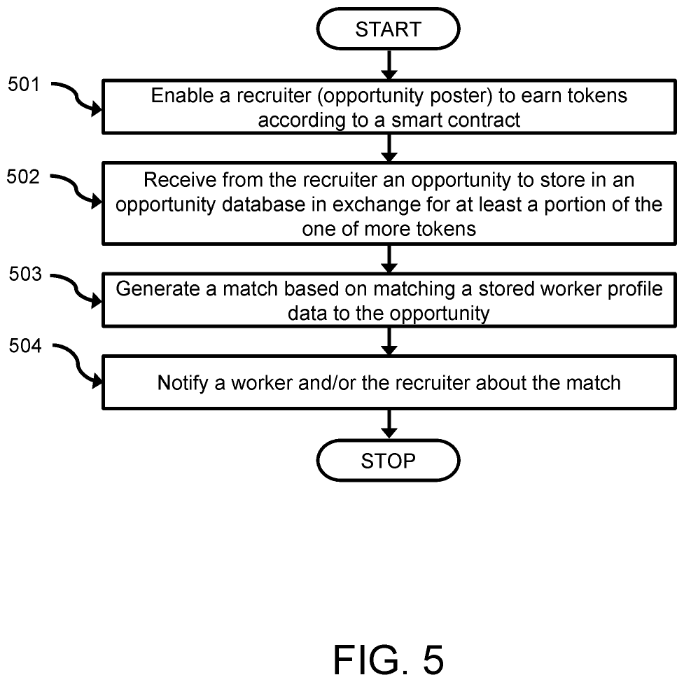

Thus, FIG. 5 shows the process enabling a recruiter or employer in a blockchain consortium and ecosystem to input an opportunity (job order) using reward tokens earned according to a smart contract and receive matches. In step 501, one or more smart contacts enable a recruiter (opportunity poster) to earn Honey tokens. In step 502, the NurseBee platform receives an opportunity and stores the opportunity in an opportunity database in exchange for at least a portion of the earned Honey tokens. In step 503, an artificial intelligence matching algorithm on the NurseBee platform generates a match based on matching worker data with opportunity data. In step 504, the NurseBee platform notifies one or more of the worker and the recruiter about the match.

In one embodiment, stablecoins power the NurseBee ecosystem 100. This offers less risk and more stability. In another embodiment, a new NurseBee-specific token can be launched. In one embodiment, whether or not to do a token sale can be a proposal for the DAO. Other options for implementing voting include MakerDAO's DAI or Stellar's Lumen.

In one embodiment, the NurseBee reward system includes a user interface (UI) generator module that, when executed by a hardware-based processing system, generates at least one user interface at a computer of at least one user. Each Hive participant may have a different user interface.

As an example, in one embodiment, a clinician interface would request credential upload. A credential could be a nurse/doctor licensing board certifications (such as a BLS, Nursing License, Physical, TB, Skills Tests) or a college transcript. Certifications required would also depend on the facility or client type. For example, a nursing home might require different credentials than an acute care hospital. Blockchain technology is used to immutably and securely store, verify, and/or retrieve credentialing documents. In one embodiment, a facility (employer) requests the clinician's verified credentials in order to approve her for shifts and pays a honey payment to NurseBee. The clinician's certifications are sent to a credentialling company for verification. NurseBee pays the credentialing company using honey or money from the HoneyPot for the verification. Upon receiving the credential verification, rewards (Honey) are sent to the clinician's wallet.

The clinician could also, for example, upload a PDF document or could provide a Honey token containing the credentials via the NurseBee Mobile or Web App. The NurseBee Platform analyzes those credentials and use various data sources to automate the verification process of such credentials against various data sources using Application Programming Interfaces to tap into external data sources and with the use of algorithm to determine the veracity of such credentials. Alternatively, the clinician could request that a school or credentialling entity upload the credentials. The school would be acting as a NurseBee service provider and would receive payment from the NurseBee HoneyPot (treasury) for providing the credentials in the form of money or honey. After credentials are uploaded, the clinician receives a reward for uploading credentials. A credentialling team can also be rewarded for facilitating the process. Different reward amounts could be provided based on the method of credential uploading. For example, if the clinician uploaded a PDF of credentials, it could be viewed as not being as trustworthy as a school uploading credentials. Therefore, more rewards could be given to the clinician uploading official documents representing their credentials. In one embodiment, the fees for paying to receive credentials could be paid by the facilities or recruitment agencies trying to verify credentials. They could pay for such service in fiat currency or cryptocurrency via Honey.

In one embodiment, the NurseBee AI Verification Module can automate the verification of nurses' licenses, certifications, and education credentials by cross-referencing information with official databases State nursing boards (like Nursys) ensuring compliance with regulatory requirements. The NurseBee AI Verification Module can also perform background checks by scanning public records through tools like TruthFinder and online sources such as social media profiles and news articles to identify any red flags or discrepancies in a candidate's history.

In one embodiment, shifts could be funded on demand. For example, a clinician is open to working extra shifts this week. The clinician uses the NurseBee platform to set filters to show the shifts available for the times she is able. The clinician can then select the desired shifts. After the shifts are complete, the clinician can receive payment through the NurseBee platform. Based on the shifts worked or her use of the NurseBee platform, through a financial service provider, the clinician may qualify for a cash advance loan, get paid a week early, or qualify for zero-interest loans.

In one embodiment, a clinician can create an “ideal shift” using the NurseBee platform. For example, if the clinician is looking for a new employer with better perks and working conditions, the clinician can use the NurseBee facility rating system to show her the best places to work. The clinician can then apply to the open opportunities that have been posted on the platform by recruiters or by the facilities. NurseBee monitors the application status and can require that each candidate receives a decision on the application. The NurseBee platform keeps the clinician updated with continuous notifications including for the ability to get placed on a same-day shift. If the clinician does secure a new position, rewards (Honey) can be provided to the recruiter that posted the position.

In another embodiment the NurseBee platform can provide additional placement assistance and recommendations. The Nurse Placement Module can recommend the best placement for nurses by considering their skills, experience, preferences, and the specific needs of hospitals. The Nurse Placement Module can also assist in optimizing nurse shift schedules, considering factors like nurse availability, patient load, and fatigue management. The Nurse Placement Module can also continuously monitor nurses' performance, assessing metrics like patient outcomes, adherence to protocols, and feedback from patients and peers. This data can be obtained through the onboarding process, resume data (infer based on heuristics), clinician interview data stored in an ATS, the NurseBee chatbot, or surveys.) The Nurse Placement Module can also offer personalized training and development plans for nurses, helping them enhance their skills and adapt to changing healthcare environments. The Nurse Placement Module can also identify nurses at risk of leaving their positions and provide insights to hospitals on how to improve retention through better work-life balance, career advancement opportunities, or additional training.

In one embodiment, Facilities (Employers) can post jobs. Facilities are incentivized to post opportunities on the NurseBee platform by the honey they accrue for posting those opportunities. Companies that post jobs and hire through NurseBee receive more confidence rankings in the app. This gives them higher placement in medical practitioner searches. Other perks include access to top talent before the competition and last-minute free emergency broadcasting service.

In one embodiment, insurance companies can provide services on the NurseBee platform. Clinicians, such as nurses, purchase insurance on the NurseBee platform. This payment can be subsidized by the HoneyPot if such a proposal is voted-in by the DAO. Both NurseBee as a company and The HoneyPot earn a percentage of the payment as a finder's fee. In one embodiment, the nurses could vote on a P2P insurance model similar to Lemonade.

In one embodiment, the NurseBee platform can provide a robo financial advisor and personal finance aids. Clinicians can access various services on the platform with payments, rewards earned, tenure, or amount generated. This feature offers preemptive advice to the nurses concerning their earnings from the facilities and the other rewards in the ecosystem.

In one embodiment, the NurseBee platform can offer mental health services. To combat the amount of stress that comes with the work of a nurse, a mental health in-app feature is provided. The mental health feature offers yoga selections, calming tea options, soothing music, a friend to talk to about the day's challenges, and more. Clinicians, such as nurses, can permanently access this service on the platform with payments, rewards earned, tenure, or amounts generated. This feature offers nurses/clinicians emotional and mental support 24/7.

In one embodiment, NurseBee can provide childcare search services. According to the NCBI, 77% of nurses in the United States are parents or caretakers of children or individuals that cannot be left to cater to themselves. NurseBee provides a map finder for such facilities in the area around their current location or their intended workstation. Clinicians, such as nurses, can permanently access this service on the platform with payments, rewards earned, tenure, or amounts generated.

In one embodiment, NurseBee can provide scholarship/educational advice. The NurseBee platform can provide clinicians with access to nano degrees and other certificate courses through NurseBee. Clinicians, such as nurses, can permanently access this service on the platform with payments, rewards earned, tenure, or amounts generated. This action will also be used in preference ranking. For example, if a nurse enrolls in continuing educating via NurseBee University, then the nurse would rank higher in employer search results or see preferred jobs sooner than the next nurse in a job search. The NurseBee AI Advisor can provide, for example, nurse-friendly programs that fit a nurses' schedule. To do this, a calendaring software such as Google Calendar can be incorporated into the NurseBee app. The AI Advisor provides a result listing the subsidized and unsubsidized nano degrees offered in-app.

In one embodiment, a medical staffing agency (a Zee) can reward Clinicians with the desired behavior (such as happy facilities, being available, tenure, continuing education) with a lower commission rate for filling a job order. Rewards enable the medical staffing agency to understand which clinicians would be easier to place and offer a discount for placing that clinician. Clinicians with the most rewards can earn more money by unlocking premium jobs. More Rewards, More Benefits.

In one embodiment, NurseBee can sell proper work-aiding attire. Providing attire recommendations based on data in the NurseBee such as occupation, specialization, and job-related pain can enable comfort and efficiency whilst on the job. For example, a nurse might report that she has shin splints to the NurseBee AI Advisor. The AI Advisor could recommend compression socks. Private payment may be made for the socks or NurseBee Honey can be redeemed towards the purchase of such attire facilitated through the integration of a healthcare retailer such as Dickies or Medline.

In one embodiment, the NurseBee platform may provide pharmacological advice. The Pharmacist in-app feature gives preliminary information about specific medications and how they interact with other drugs and conditions of the patient as input by the clinician. Integration with a clinical decision support tool such as Epocrates would enable Honey redemption.

In one embodiment the NurseBee platform can provide resume screening. NurseBee's resume screening module can automatically screen nurse resumes, identifying key qualifications, certifications, and experience, and ranking candidates based on their suitability for specific positions. First, resumes are collected from various sources, such as job portals, email submissions, or file uploads. The resumes undergo text preprocessing to remove noise, standardize formats, and prepare them for analysis. Relevant information is then extracted from resumes, including education history, certifications, work experience, skills, and contact details. NurseBee employs a trained machine learning model that has learned from a vast dataset of nursing resumes and job descriptions. This model assigns a relevance score to each resume based on how well it matches the job requirements. Next, resumes are scored, ranked, and categorized into different tiers, making it easier for recruiters to prioritize their review. Finally, recruiters access NurseBee through an intuitive user interface where they can view resume summaries, scores, and recommendations.

NurseBee's resume screening module identifies relevant keywords in resumes and matches them with job-specific keywords, certifications, and qualifications. It understands the context of the information presented in resumes, allowing it to differentiate between candidates with similar qualifications but varying experiences. Recruiters can customize the scoring criteria to align with the specific needs of their organization or individual job postings. Resumes are automatically categorized based on their relevance and suitability for different nursing roles, such as pediatric nursing, ICU nursing, or surgical nursing.

In one embodiment the NurseBee platform can provide predictive analytics. NurseBee Predictive Analytics can analyze historical hiring data to predict which candidates are more likely to succeed in a given role or within a particular hospital's work culture. It can also forecast potential turnover rates. NurseBee Predictive Analytics Predicts future nurse staffing requirements based on historical patient demand patterns, seasonality, and population health trends. It assesses the likelihood of a candidate's success in a specific nursing role, considering their qualifications and past performance data. It identifies nurses at risk of leaving their positions, allowing proactive retention strategies to be implemented. NurseBee Predictive Analytics also measures the effectiveness of past recruitment efforts and identifies areas for improvement.

In one embodiment the NurseBee platform can provide chatbots and virtual assistants. The NurseBee chatbot can engage with potential candidates, answer frequently asked questions, and collect preliminary information, making the initial recruitment process more efficient. The NurseBee chatbot initiates conversations with candidates, answering their questions and guiding them through the application process. It provides instant responses to frequently asked questions regarding job requirements, benefits, and the application process. The NurseBee chatbot also allows candidates to start the application process, collecting basic information for initial screening. The NurseBee chatbot assists candidates in creating and updating their profiles, ensuring all necessary information is captured accurately. The chatbot also schedules interviews and assessments, coordinating with candidates and recruiters.

In multiple embodiments, the NurseBee platform can match people to various parts or parties of the ecosystem. The AI matching algorithm employed by NurseBee is based on a combination of techniques, including machine learning and natural language processing (NLP). The algorithm ingests data on candidate profiles and job postings, extracting relevant information such as skills, experience, certifications, and location. Features are engineered from the data, creating a structured representation of candidate qualifications and job requirements. Machine learning models are trained on historical data, learning the patterns and relationships between candidate attributes and job criteria. The model assigns a compatibility score to each candidate job pairing, considering the degree of alignment between the candidate's qualifications and the job's requirements. When a new job posting is added or a candidate profile is updated, the algorithm quickly identifies suitable matches in real-time.

In one embodiment the NurseBee platform can provide candidate matching. AI algorithms can match candidate profiles with job requirements, considering factors like skills, experience, location, and shift preferences. NurseBee Candidate Matching offers AI-Powered Matching which utilizes advanced machine learning algorithms to match candidates with job positions based on qualifications, skills, experience, and preferences. NurseBee Candidate Matching allows organizations to set specific matching criteria and preferences to align with their unique recruitment needs. NurseBee Candidate Matching provides real-time matching results, enabling recruiters to quickly identify suitable candidates for open positions. NurseBee Candidate Matching also ranks matched candidates based on compatibility with job requirements, streamlining the selection process.

In one embodiment the NurseBee platform can provide hospital matching. The Hospital Matching AI Module can analyze hospital data, including size, location, patient demographics, technology infrastructure, and nurse-patient ratios to create detailed profiles for the hospital. Nurses' preferences can be gathered through surveys or interactions with AI chatbots. The Hospital Matching AI Module can then match nurses with hospitals that align with their preferences. The Hospital Matching AI Module can also predict hospital staffing needs based on historical data, seasonal trends, and patient demand, helping hospitals proactively plan their nurse recruitment. The Hospital Matching AI Module can also assess a nurse's cultural fit with a particular hospital by analyzing personality traits and values through structured assessments and customized questionaries built through hospital feedback.

Clinicians can permanently access this service on the platform with payments, rewards earned, tenure, or amounts generated. In one embodiment, the NurseBee platform can provide tips and other helpful measures to help our overworked, stressed-out clinicians rest better. Other features include white noise for sleep, automatic notification blocking, and auto-set alarms for waking. Clinicians can permanently access this service on the platform with payments, rewards earned, tenure, or amounts generated. Clinicians can permanently access this service on the platform with payments, rewards earned, tenure, or amounts generated.

In one embodiment, the NurseBee platform can propose carpooling when multiple clinicians live near each other and take a shift at the same location at the same time. The driver can earn honey from the clinician passengers.

In one embodiment, the NurseBee platform can propose services for a travel nurse/clinician. Services that can be offered include: travel assistance (such as Kayak); lodging assistance (such as Airbnb); food assistance (such as DoorDash); and services (such as Task Rabbit).

This invention, the NurseBee platform, can be implemented in digital electronic circuitry, computer hardware, firmware, software, or in combinations thereof. The invention can be implemented as a computer program product such as a computer program tangibly embodied in an information carrier (e.g., in a machine readable storage device or in a propagated signal), for execution by, or to control the operation of, data processing apparatus (e.g., a programmable processor, a computer, or multiple computers). A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Each computer includes a network interface, a processor, and memory. Example implementations of the computers include, but are not limited to, personal computers (PC), Macintosh computers, server computers, blade servers, workstations, laptop computers, kiosks, hand-held devices, such as a personal digital assistant (PDA), mobile phones, smartphones, tablets, and network terminals.

Method steps of the invention can be performed by one or more programmable processors executing a computer program to perform functions of the invention by operating on input data and generating output. Method steps can also be performed by, and apparatus of the invention can be implemented as, special purpose logic circuitry, such as an FPGA (field programmable gate array) or an ASIC (application specific integrated circuit).

Processors suitable for the execution of a computer program include, by way of example, both general and special purpose microprocessors, and any one or more processors of any kind of digital computer. The processor may be implemented using any suitable processing system, such as one or more processors, controllers, microprocessors, microcontrollers, processing cores and/or other computing resources spread across any number of distributed or integrated systems, including any number of “cloud-based” or other virtual systems. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). Information carriers suitable for embodying computer program instructions and data include all forms of non-volatile memory, including by way of example semiconductor memory devices (e.g., EPROM, EEPROM, and flash memory devices; magnetic disks such as internal hard disks or removable disks; magneto-optical disks; and CD ROM and DVD-ROM disks). The processor and the memory can be supplemented by, or incorporated in, special purpose logic circuitry.

A network interface is in communication with one or more databases (such as Oracle) for receiving data from a user device, a browser, or an application and transferring data to the NurseBee platform as shown in FIG. 2 and FIG. 3. A network interface is also in communication with one or more smart contracts for sending and receiving data from the NurseBee platform as shown in FIG. 2 and FIG. 3. The communication can be across a network (not shown), embodiments of which include, but are not limited to, local-area networks (LAN), metro-area networks (MAN), and wide-area networks (WAN), such as the Internet or World Wide Web.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the event of inconsistent usages between this document and those documents so incorporated by reference, the usage in the incorporated reference(s) should be considered supplementary to that of this document; for irreconcilable inconsistencies, the usage in this document controls.

We hereby claim:

1. A system comprising:
a voting interface, the voting interface adapted to receive a vote from a member, the vote related to a new service offered by a new service provider, the new service to be offered on a rewards redemption application, the rewards redemption application based on plurality of token rewards, the plurality of token rewards distributed according to at least a first smart contract;
one or more processors, at least one of the one or more processors adapted to determine using at least a second smart contract that the new service is voted-in;
a payment interface, the payment interface adapted to receive a fee from the new service provider and deposit the fee in a treasury account; and
a service database, the service database adapted to offer the new service in exchange for one or more rewards, wherein the one or more rewards are one or more of: a stablecoin, a token, and a cryptocurrency.

2. The system of claim 1, further comprising:
an opportunity interface, the opportunity interface adapted to enable an opportunity poster to input an opportunity for storage in an opportunity database in exchange for a first portion of rewards;
a worker database, the worker database adapted to store a worker profile of a worker, wherein at least one of the one or more processors adapted to match the worker profile to the opportunity; and
a worker interface, the worker interface adapted to display the opportunity to the worker.

3. The system of claim 2, wherein one or more of a recruiter and a facility receive a reward for posting the opportunity.

4. The system of claim 1, wherein the new service is one or more of a perk, a benefit, and a service.

5. The system of claim 1 further comprising a service provider interface, the service provider adapted for a service provider to upload an indication of the new service.

6. The system of claim 1 further comprising an employer interface, the employer interface adapted for an employer to hire the worker.

7. The system of claim 6, wherein upon the employer hiring the worker, one or more of:
the worker is provided with a worker reward, wherein the worker reward is a first portion of the plurality of token rewards;
the employer is provided with an employer reward, wherein the employer reward is a second portion of the plurality of token rewards; and
a recruiter is provided with a recruiter reward if the worker and the employer were connected by the recruiter, wherein the recruiter reward is a third portion of the token rewards.

8. The system of claim 1 wherein at least one of the one or more processors is adapted to generate at least one of the plurality of rewards, wherein the at least one of the plurality of rewards are rewarded based at least in part on one or more of:
a worker signup;
a worker profile creation;
an uploaded worker credential;
a worker referral;
a recruiter signup;
a recruiter profile creation;
a recruiter referral;
a recruiter source;
a resume screen;
a recruiter connect;
worker tenure;
work cumulative duration;
worker overtime;
worker training;
worker earnings;
a connection; (a match for clinicians and providers)
recruiter earnings;
a shared contact;
a provided rating;
a received good rating;
a received good job review;
a provided comment; and
a completed task.

9. The system of claim 1 wherein the treasury account is a crypto wallet and is controlled by a decentralized autonomous organization (DAO).

10. The system of claim 1, wherein the treasury account obtains funds from one or more of:
membership fees; and
transactional fees.

11. The system of claim 1, wherein the new service is one or more of:
an insurance-related service;
a banking related service;
an investing-related service;
an educational service;
a credentialing service; and
a wellness-related service.

12. The system of claim 1, wherein the participant can earn and spend token rewards.

13. A system comprising:
a token reward interface, the token reward interface adapted to enable an opportunity poster to earn one or more tokens according to a smart contract stored on a blockchain;
an opportunity interface, the opportunity interface adapted to enable the opportunity poster to input an opportunity for storage in an opportunity database in exchange for at least a portion of the one or more tokens;
one or more processors, the one or more processors adapted to generate a match, the match matching a worker profile to the opportunity, the worker profile stored in a worker database; and
a notification interface, the notification interface adapted to send the match to one or more of the worker and the opportunity poster.

14. The system of claim 13, wherein the one or more tokens can be paid out in stablecoin.

15. A method comprising:
receiving from a worker, via a token, one or more credentials;
analyzing, using one or more data sources, the one or more credentials to determine whether the one or more credentials are verified;
if the one or more credentials are determined to be verified, rewarding the worker with a token reward according to a smart contract stored on a blockchain.
